(19) United States
(12) Patent Application Publication
(10) Pub. No.: US 2006/0220966 A1
(43) Pub. Date: Oct. 5, 2006

(54) Antenna element-counterpoise arrangement in an antenna

(75) Inventors: Andrey Sarychev, San Diego, CA (US); Sebastian Rowson, San Diego, CA (US); Leslie James Reading, Spring Valley, CA (US)

Correspondence Address: FOLEY & LARDNER LLP, 321 NORTH CLARK STREET, SUITE 2800, CHICAGO, IL, 60610-4764, US

(73) Assignee: Ethertronics

(21) Appl. No.: 11/180,215

(22) Filed: Jul. 13, 2005

Related U.S. Application Data
(60) Provisional application No. 60/666,759, filed on Mar. 29, 2005.

(51) Int. Cl. H01Q 1/24

(52) U.S. Cl. 343/702; 343/700 MS; 343/895

(57) ABSTRACT

An antenna comprising an antenna element and a counterpoise. The antenna element is positioned to minimize capacitive coupling between the antenna element and the counterpoise. In one embodiment no portion of the antenna element overlaps the counterpoise decreasing the distributed capacitance between the antenna element and the counterpoise and increasing the effective bandwidth of the antenna. The antenna element can be configured to couple with substantially all of the counterpoise to radiate at a resonant frequency.

### CROSS REFERENCE TO RELATED APPLICATION

This application claims priority to U.S. Provisional Patent Application No. 60/666,759 filed Mar. 29, 2005, entitled “Element Designs for Electrically Small Antennas,” which is incorporated herein by reference.

### FIELD OF THE INVENTION

The present invention relates generally to the field of antennas. More particularly, the present invention relates to electrically small antennas.

### BACKGROUND INFORMATION

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Electrically small antennas have unique properties and issues. There are many different antenna models, such as the simple resonant cavity and the multi-resonant cavity, and structures, such as the gamma match structure, the counterpoise, etc. These types of antennas and structures are frequently used in a wide variety of products of varying shapes and sizes, for example as an internal antenna for a mobile telephone.

A simple resonant cavity is typically an antenna having a coarse resonant cavitiy with intentionally high internal losses. Some of these losses are due to radiation resistance resulting in useful radiation. Other losses are non-productive and the energy absorbed by them is transferred to heat.

Electrically small antennas of this type are characteristically two-pole resonators which can be described generally as series resonant or parallel resonant. For the purposes of this explanation, a series resonant two-pole cavity resonator passes through resonance from the capacitive region of the Smith Chart to the inductive region with increasing frequency (an ascending profile). A parallel resonant two-pole cavity passes from the inductive region to the capacitive region with increasing frequency (a descending profile).

Turning now to multi-resonant cavity antennas, because an antenna is a distributed electromagnetic structure, an antenna that is series resonant in its fundamental mode is parallel resonant at its next higher mode. That is, a series resonant antenna passes through the horizontal axis of the Smith Chart at its fundamental frequency with a low resistance and as frequency increases it passes through the horizontal axis of the Smith Chart again at a higher resistance. Generally speaking, this second resonant frequency (parallel resonance or anti-resonance) can be approximately twice the frequency of the series resonant fundamental frequency. By further increasing frequency, the antenna passes through series resonance again at approximately three times the fundamental frequency.

In fact, all distributed resonant systems have higher resonant modes, also known as re-entrant modes. In simple resonating cavities, these re-entrant modes are related to the fundamental mode (the lowest Eigenmode) by occurring at odd harmonics of the fundamental frequency. In practice, these higher modes can be subject to degenerative conditions, such as parasitic and dispersive effects. In the case of an Isolated Magnetic Dipole (IMD), these higher modes can be engineered to occur at specific frequencies to produce favorable multi-band properties.

In it most general form, a resonant cavity can be accurately modeled as a lossy transmission line. Unlike regular transmission lines, the distributed elements of most real-world radiating structures are not symmetrical. In addition, there are parasitic modes in many radiating structures, some of them being added intentionally. The dual band Planar Inverted F Antenna (PIFA) is one such structure where a separate radiating mode can be added in order to produce a high band response that lies between the first and third natural Eigenmodes. The high band response in this case is generally not a re-entrant mode but is a parasitic mode.

For electrically small antennas, it is generally the case that the series resonant resistance is too low to be useful and the parallel resonant resistance is too high. Such structures can be impedance-matched to a feed line, generally having a characteristic impedance of 50 ohms with a specified range of acceptable maximum return loss. Because of its low cost, simplicity, and effectiveness the Gamma Match is the most widely used impedance matching structure.

One way that this technique can be implemented is by grounding the series radiating structure, finding a tap point on the radiating structure that corresponds to approximately 50 ohms, and compensating (or accepting) the series reactance of the feed leg. The Gamma Match can be derived from a simple tapped resonator. Since mutual coupling can generally be ignored in most planar antenna structures, it can be reduced to a simple tapped structure. In many cases of internal antenna, it is necessary to bring the tap point to a feeding pad using a structure that is similar in inductance to the ground leg.

The dominant radiating mechanism for a mobile communication device with an internal antenna can be the counterpoise, which in many cases comprises the circuit board and/or the device case. The antenna elements provide a decoupled reactive load against which the counterpoise provides radiating resistance. As such, there is a need for an antenna design which takes advantage of the antenna element/counterpoise interaction to produce improved properties.

### SUMMARY OF THE INVENTION

One embodiment of the invention relates to an antenna configured to radiate at a resonant frequency. The antenna can include an antenna element and a counterpoise positioned such that no portion of the counterpoise overlaps with the antenna element, yet close enough to the counterpoise so that the antenna element couples with the counterpoise causing substantially all of the counterpoise to radiate at the resonant frequency. The antenna element can be positioned above the counterpoise, below the counterpoise or in the same plane as the counterpoise. The counterpoise and the antenna element can be positioned substantially parallel to each other or substantially perpendicular to each other. The antenna element can be a meander element, a frame element, an IMD element, or any other suitable style of antenna element. The antenna can also include a parasitic antenna element positioned such that no portion of the parasitic antenna element overlaps with the counterpoise. A feed line can also be included connected to the antenna element and near one end of the counterpoise.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

FIG. 1 is a block diagram of an antenna element, counterpoise, feedline arrangement for a conventional internal antenna.

FIG. 2 is a block diagram of an antenna element, counterpoise, feedline arrangement for another conventional internal antenna.

FIG. 3 is a block diagram of one embodiment of an antenna element-counterpoise arrangement of the present invention.

FIG. 4 is a block diagram of another embodiment of an antenna element-counterpoise arrangement of the present invention.

FIG. 5 is a perspective block diagram of an embodiment of an antenna element-counterpoise arrangement of the present invention.

FIG. 6 is a perspective block diagram of an embodiment of an antenna element-counterpoise arrangement of the present invention.

FIG. 7 is a perspective block diagram of an embodiment of an antenna element-counterpoise arrangement of the present invention.

FIG. 8 is a perspective block diagram of an embodiment of an antenna element-counterpoise arrangement of the present invention.

FIG. 9 is a perspective block diagram of an embodiment of an antenna element-counterpoise arrangement of the present invention.

FIG. 10 is a block diagram of another embodiment of an antenna element-counterpoise arrangement of the present invention.

FIG. 11 is a perspective block diagram of an embodiment of an antenna element-counterpoise arrangement of the present invention.

FIG. 12 is a perspective block diagram of an embodiment of an antenna element-counterpoise arrangement of the present invention.

### DETAILED DESCRIPTION OF THE PREFERRED EMBODIMENTS

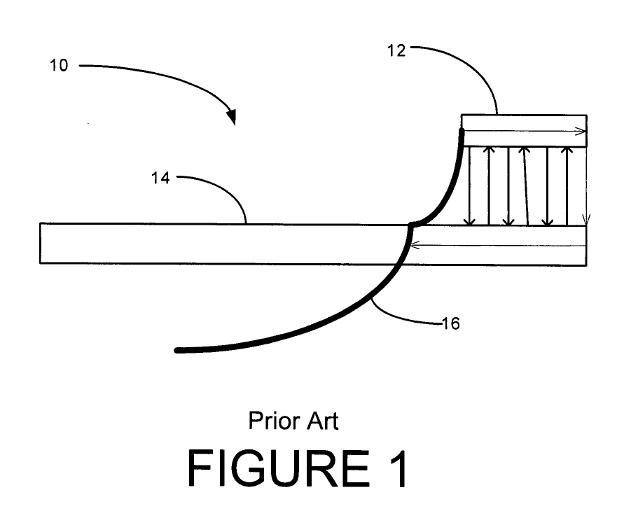

Referring to FIG. 1, an internal, also referred to as embedded, antenna 10 generally comprises an antenna element 12, a counterpoise 14 and a feed line 16. The feed line 14 is usually connected to both the antenna element 12 and the counterpoise 14. In most applications, the Eigenmode of an antenna element has a very high Q (a very small bandwidth) and the radiation resistance from the counterpoise lowers the apparent Q, thereby increasing the observed bandwidth. The feed point (and ground point) for the antenna element located on the counterpoise is situated to stimulate the proper Eigenmode on the counterpoise so that it reflects useful radiation resistance to the element.

For example, placing the feed pads in the center of the counterpoise removes all the radiating properties of the counterpoise, since the vector sums of the currents on the counterpoise are almost self-canceling and therefore radiate inefficiently. Likewise, a counterpoise with a length of one-half wavelength produces very little useful radiation resistance, even when pads are placed at the end of the counterpoise.

The antenna element 12-counterpoise 14 arrangement of FIG. 1 creates a large capacitive coupling between the antenna element 12 and the counterpoise 14 in the area between the antenna element 12 and counterpoise 14. This capacitive couple dominates the coupling between the antenna element 12 and the counterpoise 14. As a result, a large portion of the counterpoise 14 does not couple with the antenna element 12 in any useful manner (i.e. the area of the counterpoise 14 which does not overlap with the antenna element). This arrangement of distributed capacitance does not take full advantage of the radiating properties of the counterpoise 14.

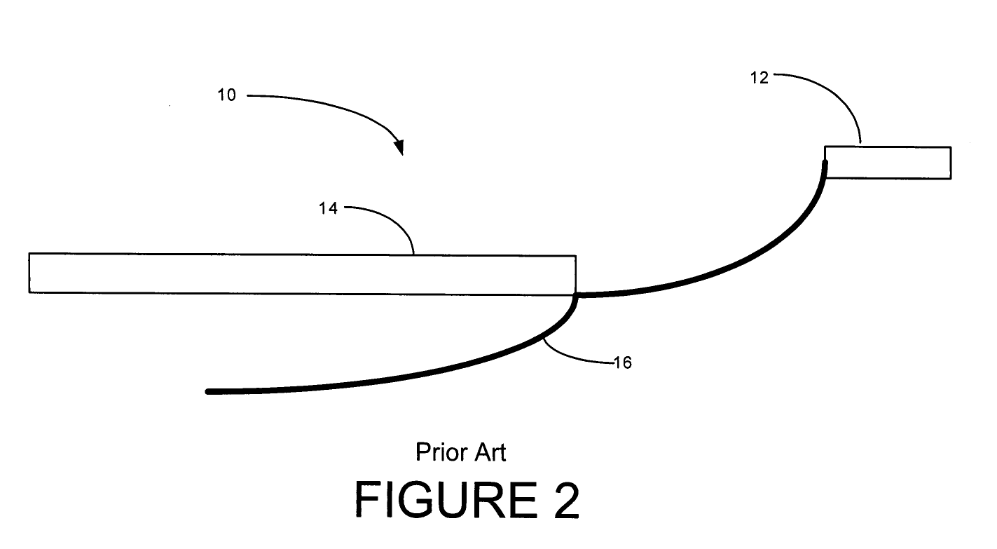

In other conventional antenna designs, the antenna element 12 and counterpoise 14 may be arranged very far apart as shown in FIG. 2. However, because the space occupied by the antenna element 12 and counterpoise 14 is typically fixed by the application. For example, if the antenna 10 is used in a mobile telephone, the counterpoise 14 and antenna element 12 must fit inside the mobile telephone. As such, the physical limitations of the application require that at a certain point the only way to further increase the distance between the antenna element 12 and the counterpoise 14 is to decrease the size of the counterpoise 14. In this design, there is virtually no coupling between the antenna element 12 and the counterpoise 14. In this arrangement, each structure acts independently. As such, this antenna configuration also does not take full advantage of the radiating properties of the counterpoise 14.

Counterpoise management can be one of the most critical areas in designing useful internal (embedded) antennas, especially for small devices such as mobile communication devices. Mobile communication devices are typically highly-asymmetric radiating structures.

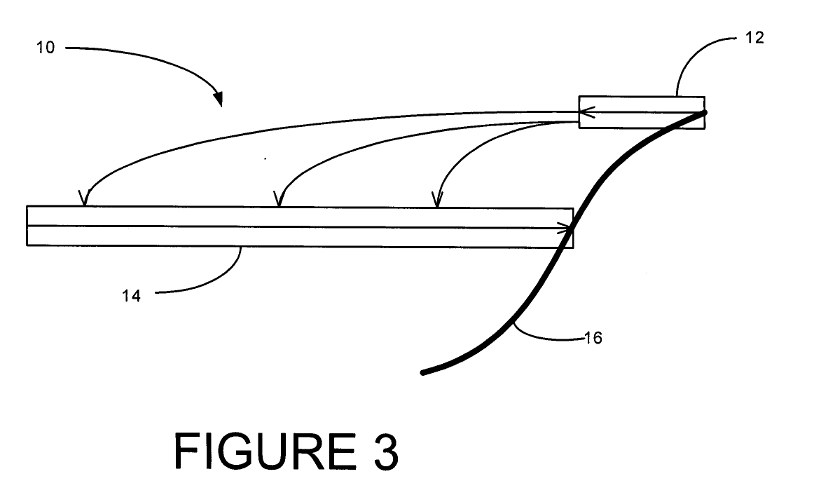

One way to expand the bandwidth of the antenna 10 is to arrange the antenna element 12 and counterpoise 14 so that capacitive coupling between the antenna element 12 and the counterpoise 14 is minimized. Of the available resistance in an antenna, only a small portion of it is used due to parasitic coupling between the counterpoise 14 and the antenna element 12. This coupling is predominantly capacitive (not inductive). One way to increase the bandwidth of the antenna 10 is to increase the usable resistance. In one embodiment of the invention, this can be done by decreasing the distributed capacitance between the antenna element 12 and the counterpoise 14. By moving the antenna element 12 away from the counterpoise 14 and attaching the feed line 16 near one end of the counterpoise 14, as shown in FIG. 3, the distributed capacitance is decreased because the antenna element 12 couples with the entire counterpoise 14 and not just the small portion of the counterpoise 14 beneath the antenna element 12. In this case, the coupling between the antenna element 12 and the area of the counterpoise 14 directly beneath the counterpoise 14 no longer dominates.

By arranging the antenna element 12, counterpoise 14, and feed line 16 in this manner, the antenna 10 can take advantage of the counterpoise radiating qualities to produce a wide band antenna. Antenna element 12-counterpoise 14 arrangement according to the present invention, create currents in both the antenna element 12 and counterpoise 14 cause each structure to radiate in a manner in which the radiation from each structure combines to product constructive radiation. In conventional antenna designs, such as the one shown in FIG. 1, the currents in the antenna element 12 and counterpoise 14 produce radiation that cancel each other to reduce the overall radiating properties of the antenna 10.

In some cases, even a small shift of the antenna element 12 outside the counterpoise 14 completely changes the operation of the antenna 10 by increasing its operational bandwidth. For example, in some designs a substantial improvement can be realized by separating the antenna element 12 and counterpoise 14 by as little as 1 millimeter. However, as explained above, the antenna element 12 and counterpoise 14 should ideally be positioned close enough to each other to take advantage of the radiating properties of the counterpoise 14. While the maximum distance between the antenna element 12 and counterpoise 14 can vary based, at least in part, on the size of the element 12 and counterpoise 14, in a typical handheld device, a maximum of 20 millimeters can be used. In one embodiment of the invention, the fundamental mode of operation of the antenna is completely different when the antenna element 12 is outside the counterpoise 14 as opposed to inside (i.e. overlapping). In a conventional antenna, the antenna element can operate as a magnetic dipole, but when the antenna element is moved outside the counterpoise, the electric dipole mode can be excited.

In various embodiments of the invention, the antenna element 12 can be arranged in the same plane as the counterpoise 14 (as opposed to the perpendicular arrangement illustrated in FIG. 3). The antenna elements 12 take a variety of different forms. For example, the antenna elements 12 could be vertical or horizontal meander elements, folded meander elements, vertical, horizontal, and/or folded IMD elements, frame elements, or any other suitable antenna element. In addition, various feed line/ground line arrangements can be used. For example, the feed line 16 can be connected to the antenna element 12 near one end of the antenna element 12. In another embodiment, the feed line 16 can be connected to the antenna element 12 near the center of the antenna element 12 and a ground line (not shown) can be connected near one end of the antenna element 12.

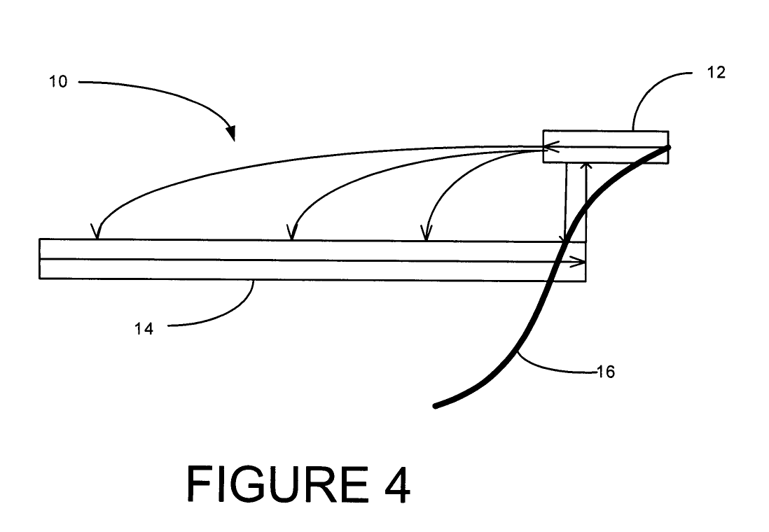

FIG. 4 illustrates another embodiment of invention in which the antenna element 12 and counterpoise 14 are positioned so that at least a portion of the antenna element 12 does not overlap the counterpoise 14, although a small portion of the antenna element 12 does overlap the counterpoise 14. In this embodiment, capacitive couple between the antenna element 12 and the counterpoise 14 is minimized by designing the antenna element 12 and counterpoise 14 size and overlap. In this embodiment, a small amount of capacitive coupling may exist in the area of overlap between the antenna element 12 and counterpoise 14, but it does not dominate. Instead, the antenna element 12 couples with the entire counterpoise 14 taking advantage of the radiating qualities of the counterpoise 14.

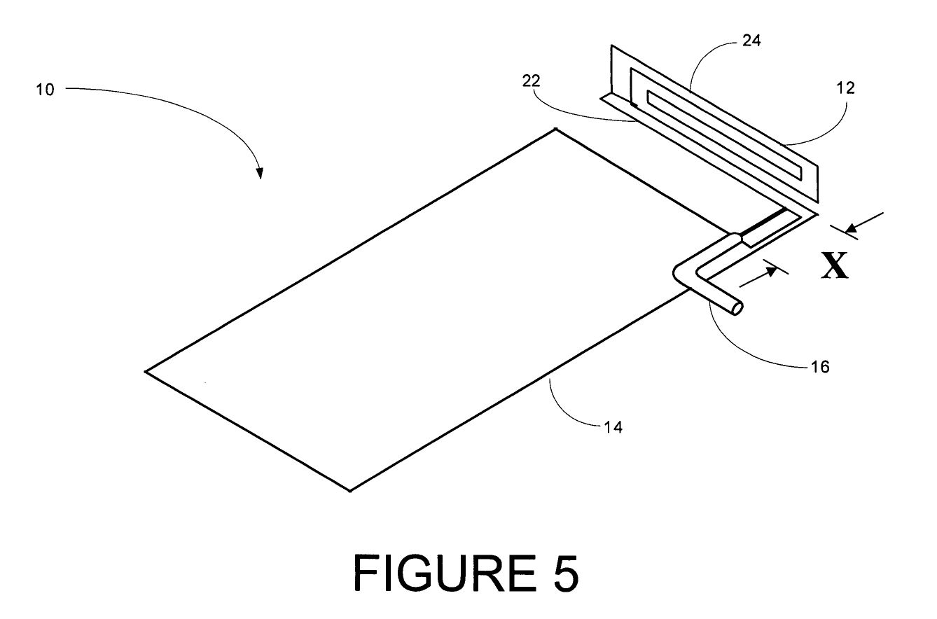

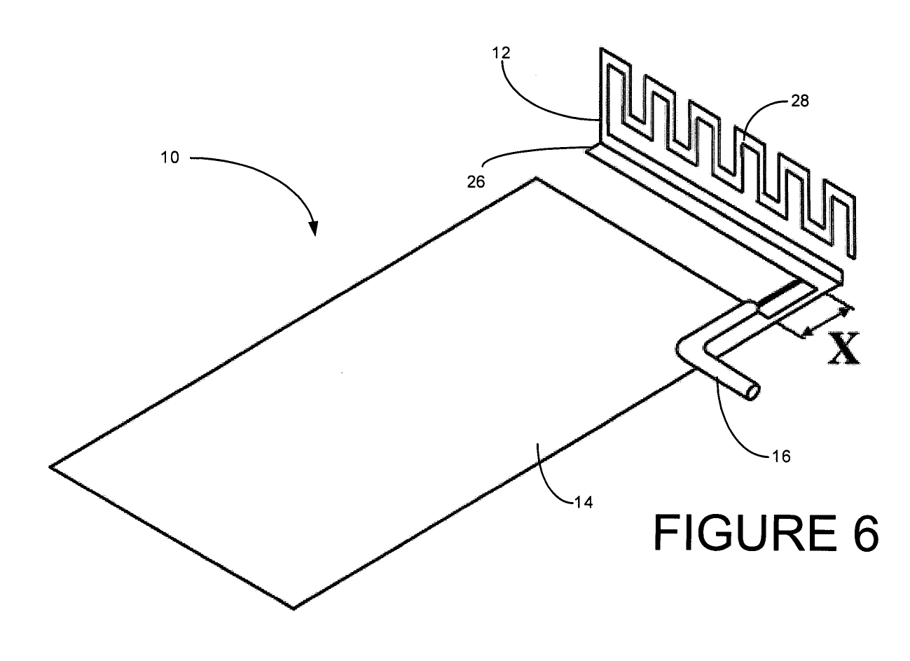

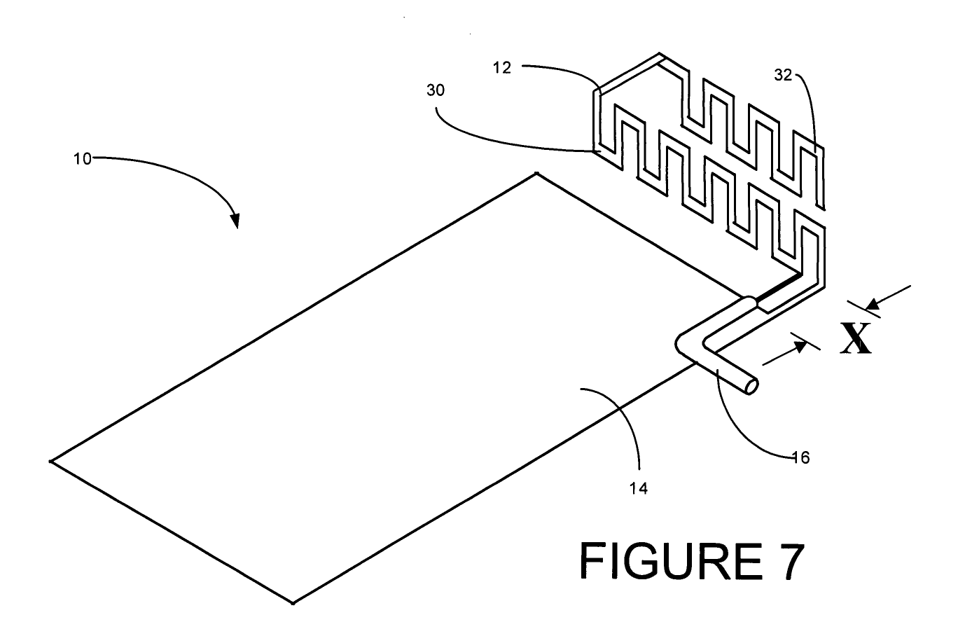

FIGS. 5-7 illustrate various embodiment of invention and in particular various styles of antenna element 12 that can exhibit dual band properties. For example, FIG. 5 shows one embodiment of the invention in which the antenna element 12 is a folded IMD element. This antenna element includes both vertical 24 and horizontal portions 22. In this embodiment, the horizontal portion 22 (i.e. the portion closest to the antenna feed 16) is primarily responsible for the high band qualities of the antenna element 12. The horizontal and vertical portions, 22 and 24 respectively, combine to create the low band properties of the antenna 12. FIG. 6 illustrates a vertical meander antenna element 26 combined with a metal vertical and/or horizontal strip 28 to form a shark antenna element 12. In a similar manner, the high band characteristics are primary created by the metal strip 28 (i.e. the portion closest to the antenna feed 16), while the combination of the vertical meander element 26 and the metal strip 28 form the low band properties. FIG. 7 illustrates a folded meander antenna element 12 which also exhibits dual band properties. This embodiment includes a front vertical meander element 30 and a back vertical meander element 32. In this embodiment, the front meander element 30 (i.e. the element closest to the antenna feed 16) creates the high band characteristics of the antenna element 12 and the combination of both the front and back meander elements 30 and 32 form the low band properties.

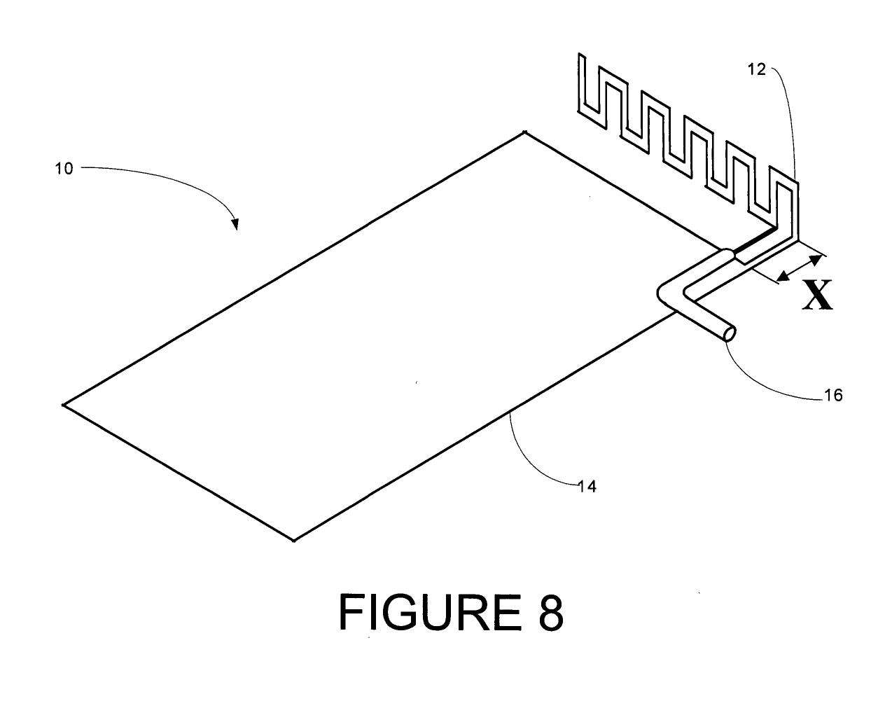

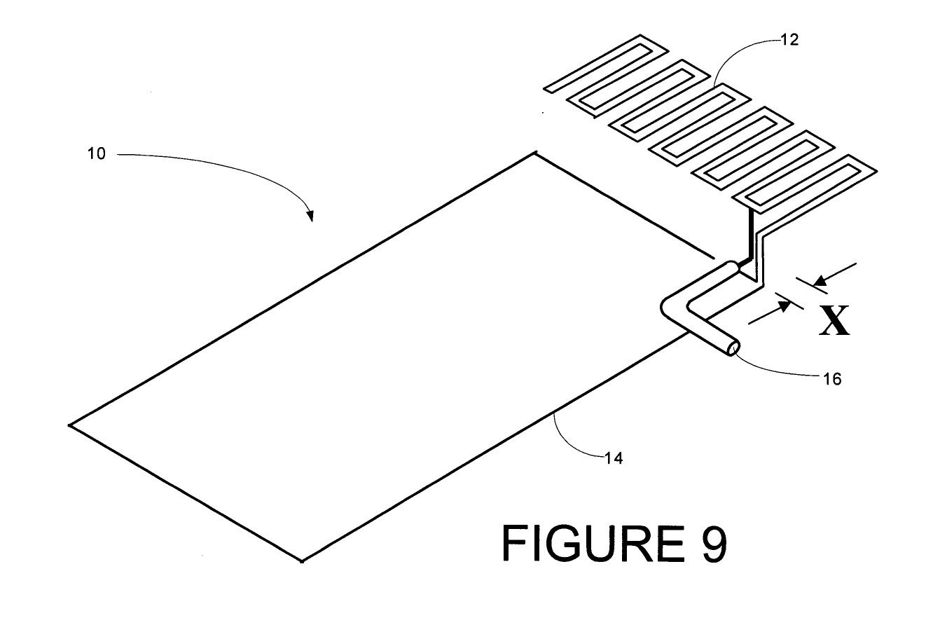

FIG. 8 shows an embodiment of the invention having a vertical meander antenna element 12 and FIG. 9 shows an embodiment of the invention having a horizontal meander antenna element 12 Various other antenna element designs and configures can be used in creating antenna according to the present invention.

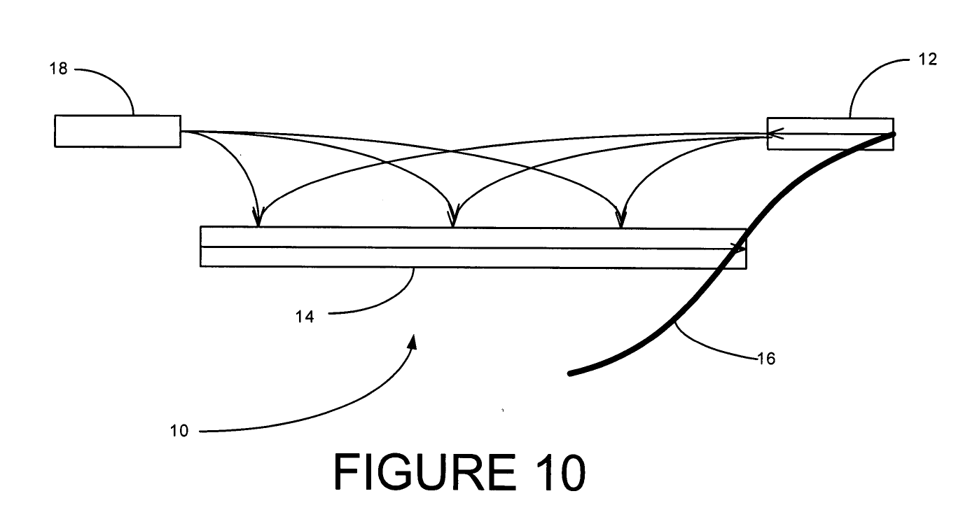

FIGS. 10-12 illustrate embodiments employing multiple antenna elements 12. In these embodiments, additional parasitic extension elements 18 can be added. The extension elements 19 can be arranged to couple with the entire counterpoise 14 in a manner similar to that of antenna element 12. Similar to the antenna element 12, the extension elements 18 can be arranged perpendicular to or in the same plane as the counterpoise 14 and can be arranged above and/or below the counterpoise 14.

As can be seen from the Figures, the extension element 18 can be positioned on an end of the counterpoise 14 opposite the antenna element 12. Similar to the antenna element 12, the extension element 18 can be positioned so that at least a portion of it does not overlap the counterpoise 14 or so that there is no overlap between the counterpoise 14 and the extension element 18. The extension element 18 is configured to couple with substantially all of the counterpoise 14 in a manner similar to the antenna element 12 thus increasing the overall coupling between the counterpoise 14 and the elements 12 and 18. The extension element 18 can be parasitically feed from coupling with the antenna element 12.

In one embodiment, the antenna element 12 is configured to resonate at a first frequency and the extension element 18 is configured to resonate at a second frequency such that the first and second frequencies are close enough to combine to product an antenna 10 having four-poles. Alternatively, the extension element 18 can be configured and arranged to create an antenna 10 that resonates at at least two resonant frequencies. The extension element 18 can make the counterpoise appear to be a first electrical length at one of the two resonant frequencies and a second electrical length at a second of the two resonant frequencies.

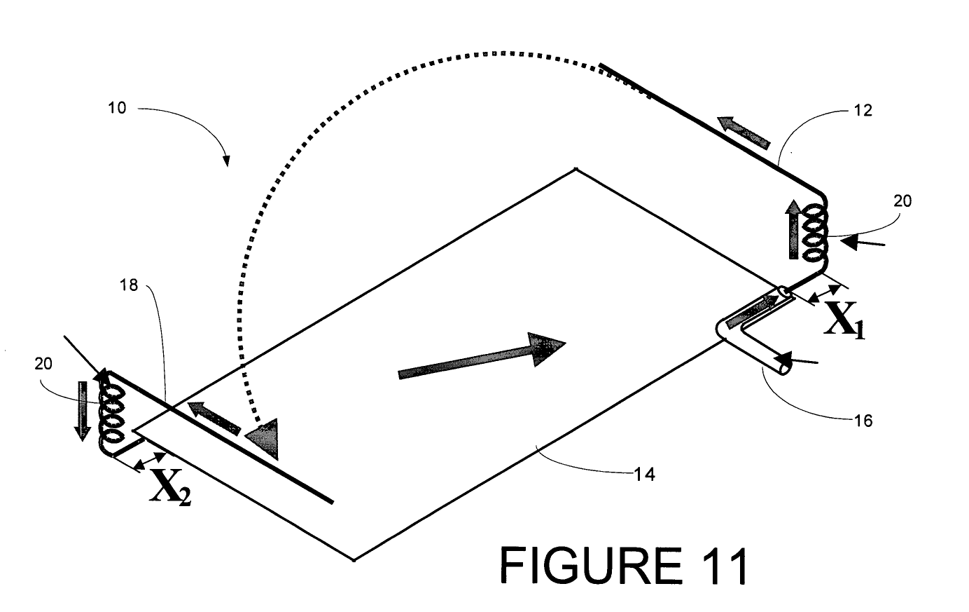

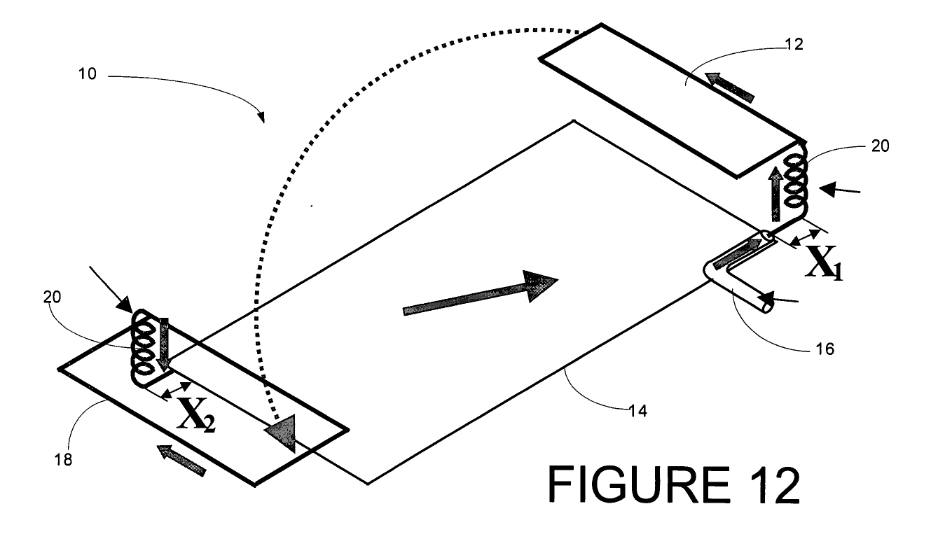

The extension element 18 can take many different forms, such as those mentioned with respect to the antenna element. FIG. 11 illustrates an embodiment of the invention in which the extension element 18 and antenna element 12 comprise stick elements. FIG. 12 illustrates an embodiment in which the extension element 18 and antenna element 12 comprise frame elements. The embodiments illustrated in FIGS. 11 and 12 also illustrate loaded inductors 20 for the antenna element 12 and extension element 18. In these embodiments, the inductors 20 take the form of a coil. The inductors 20 can also be included as part of the feeding structure of the antenna 10. Various conventional feeding structures can be employed with embodiments of the invention.

While several embodiments of the invention have been described, it is to be understood that modifications and changes will occur to those skilled in the art to which the invention pertains. Accordingly, the claims appended to this specification are intended to define the invention precisely.

What is claimed is:

1. An antenna comprising:
an antenna element; and
a counterpoise positioned such that no portion of the counterpoise overlaps with the antenna element but close enough to the antenna element to cause the counterpoise to act as a parasitic element of the antenna element.

2. The antenna of claim 1 further comprising an extension element wherein the counterpoise has first and second ends, the antenna element is positioned at the first end of the counterpoise and the extension element is positioned near the second end of the counterpoise such that the extension element increases coupling between the antenna element and the counterpoise.

3. The antenna of claim 2 wherein the antenna element and the counterpoise combine to resonate at a first frequency and the extension element and the counterpoise combine to resonate at a second frequency and wherein the first and second frequencies are close enough so that the antenna has four-poles.

4. The antenna of claim 1 wherein the antenna element comprises a multiband antenna element.

5. The antenna element of claim 4, wherein the antenna element further comprises folded IMD antenna element, a folded meander antenna element, or a shark meander antenna element.

6. The antenna of claim 2, wherein the antenna is configured to operate at at least two resonant frequencies, the antenna comprising a second extension element such that the extension element is configured to increase coupling between the antenna element and the counterpoise at a first of the at least two resonant frequencies and the second extension element is configured to increase coupling between the antenna element and the counterpoise at a second of the at least two resonant frequencies.

7. The antenna of claim 2, wherein the antenna is configured to operate at at least two resonant frequencies and the extension element is configured to make the counterpoise appear to be a first electrical length at a first of the at least two resonant frequencies and a second electrical length at a second of the at least two resonant frequencies so that the extension element increases coupling between the antenna element and the counterpoise at both the first and second resonant frequencies.

8. The antenna of claim 1 wherein the antenna element and the counterpoise are separated by at least 1 millimeter.

9. An antenna comprising:
an antenna element; and
a counterpoise positioned such that no portion of the counterpoise overlaps with the antenna element but close enough to the antenna element to cause the antenna element and counterpoise to operate in a single collective mode.

10. The antenna of claim 9 further comprising an extension element wherein the counterpoise has first and second ends, the antenna element is positioned at the first end of the counterpoise and the extension element is positioned near the second end of the counterpoise such that the extension element increases coupling between the antenna element and the counterpoise.

11. The antenna of claim 9 wherein the antenna element and the counterpoise combine to resonate at a first frequency and the extension element and the counterpoise combine to resonate at a second frequency and wherein the first and second frequencies are close enough so that the antenna has four-poles.

12. The antenna of claim 9, wherein the antenna element further comprises a multiband element.

13. The antenna element of claim 12, wherein the antenna element further comprises folded IMD antenna element, a folded meander antenna element, or a shark meander antenna element.

14. The antenna of claim 9, wherein the antenna is configured to operate at at least two resonant frequencies, the antenna comprising a second extension element such that the extension element is configured to increase coupling between the antenna element and the counterpoise at a first of the at least two resonant frequencies and the second extension element is configured to increase coupling between the antenna element and the counterpoise at a second of the at least two resonant frequencies.

15. The antenna of claim 9, wherein the antenna is configured to operate at at least two resonant frequencies and the extension element is configured to make the counterpoise appear to be a first electrical length at a first of the at least two resonant frequencies and a second electrical length at a second of the at least two resonant frequencies so that the extension element increases coupling between the antenna element and the counterpoise at both the first and second resonant frequencies.

16. An antenna comprising:
an antenna element; and
a counterpoise positioned such that at least a portion of the antenna element does not overlap with the counterpoise and the antenna element couples with substantially all of the counterpoise.

17. The antenna of claim 16 further comprising an extension element wherein the counterpoise has first and second ends, the antenna element is positioned at the first end of the counterpoise and the extension element is positioned near the second end of the counterpoise such that the extension element increases coupling between the antenna element and the counterpoise.

18. The antenna of claim 17 wherein the antenna element and the counterpoise combine to resonate at a first frequency and the extension element and the counterpoise combine to resonate at a second frequency and wherein the first and second frequencies are close enough so that the antenna has four-poles.

19. The antenna of claim 16, wherein the antenna element further comprises a multiband antenna element.

20. The antenna element of claim 19, wherein the antenna element further comprises folded IMD antenna element, a folded meander antenna element, or a shark meander antenna element.

21. The antenna of claim 16, wherein the antenna is configured to operate at at least two resonant frequencies, the antenna comprising a second extension element such that the extension element is configured to increase coupling between the antenna element and the counterpoise at a first of the at least two resonant frequencies and the second extension element is configured to increase coupling between the antenna element and the counterpoise at a second of the at least two resonant frequencies.

22. The antenna of claim 16, wherein the antenna is configured to operate at at least two resonant frequencies and the extension element is configured to make the counterpoise appear to be a first electrical length at a first of the at least two resonant frequencies and a second electrical length at a second of the at least two resonant frequencies so that the extension element increases coupling between the antenna element and the counterpoise at both the first and second resonant frequencies.

23. The antenna of claim 16, wherein the counterpoise is positioned such that no portion of the counterpoise overlaps with the antenna element.
